(19) United States
(12) Patent Application Publication
(10) Pub. No.: US 2017/0274519 A1
(43) Pub. Date: Sep. 28, 2017

(54) ADAPTER TOOL WITH MULTIPLE ATTACHMENTS

(71) Applicant: Deone Lashawne Chapman, Fredericksburg, VA (US)

(72) Inventor: Deone Lashawne Chapman, Fredericksburg, VA (US)

(21) Appl. No.: 15/619,873

(22) Filed: Jun. 12, 2017

Related U.S. Application Data
(63) Continuation-in-part of application No. 14/740,893, filed on Jun. 16, 2015, now Pat. No. 9,707,676.
(60) Provisional application No. 62/012,847, filed on Jun. 16, 2014.

(51) Int. Cl. B25F 1/02; B25F 1/00

(52) U.S. Cl. CPC B25F 1/02; B25F 1/006; B25D 2250/015

(57) ABSTRACT

An adapter tool. The adapter tool includes an elongated handle having a top end opposite a bottom end. A head is attached to and is substantially perpendicular with the handle. The head includes a first end opposite a second end. At least one of the first end and the second end may include a head mating end. A plurality of tool attachments is further provided. Each of the tool attachments includes a tool mating end releasably attachable to the head mating end. Each of the plurality of tool attachments may include a tool portion including a different type of tool. Therefore, different tool attachments may be connected to the head to form different tools.

### CROSS-REFERENCE TO RELATED APPLICATION

This application is a continuation-in-part of U.S. non-provisional application Ser. No. 14/740,893, filed Jun. 16, 2015, and claims the benefit of priority of U.S. provisional application No. 62/012,847, filed Jun. 16, 2014, the contents of which are herein incorporated by reference.

### BACKGROUND OF THE INVENTION

The present invention relates to tools and, more particularly, to an adapter tool with multiple attachments.

A tool is any physical item that can be used to achieve a goal. Tool use by humans dates back millions of years. Tools that are used in particular fields or activities may have different designations such as “instrument”, “utensil”, “implement”, “machine”, “device,” or “apparatus”. The set of tools needed to achieve a goal is “equipment”. Currently, most tools may only be used for a single purpose. Therefore, many tools must be purchased for different tasks, which is expensive and takes up a lot of space.

As can be seen, there is a need for an improved multi-purpose tool set adapter.

### SUMMARY OF THE INVENTION

In one aspect of the present invention, an adapter tool comprises: a handle comprising a top end and a bottom end; a head attached to the top end of the handle and comprising a first end and a second end, wherein at least one of the first end and the second end comprises a head mating end comprising a head opening; a plurality of tool attachments, each comprising: a tool mating end comprising a tool opening positioned to align with the head opening, wherein at least one of the tool opening and the head opening is a threaded opening; and a tool portion comprising a type of tool; and a connector comprising: a bushing sized to fit within at least one of the tool opening and head opening; a bolt disposed within the bushing and comprising a flange and a threaded pin; a spring disposed around the bolt in between the threaded pin and the flange, wherein the threaded pin is protruding from an end of the bushing and is releasably attachable to the threaded opening.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a section view of the present invention;

FIG. 3 is an exploded perspective view of the present invention;

FIG. 4 is section detail view taken along line 4-4 of FIG. 1;

FIG. 5 is a section detail view of an embodiment of the present invention;

FIG. 6 is a perspective view of a head attachment of the present invention;

FIG. 7 is a perspective view of a head attachment of the present invention;

FIG. 8 is a perspective view of a head attachment of the present invention;

FIG. 9 is a perspective view of a head attachment of the present invention;

FIG. 10 is a perspective view of a head attachment of the present invention;

FIG. 11 is a perspective view of a head attachment of the present invention;

FIG. 12 is a perspective view of a head attachment of the present invention;

FIG. 13 is a perspective view of a head attachment of the present invention;

FIG. 14 is a perspective view of a head attachment of the present invention;

FIG. 15 is a perspective view of the present invention;

FIG. 16 is an exploded perspective view of the present invention;

FIG. 17 is section detail view taken along line 17-17 of FIG. 15;

FIG. 18 is a perspective view of the present invention;

FIG. 19 is an exploded perspective view of the present invention;

FIG. 20 is section detail view taken along line 20-20 of FIG. 18;

FIG. 21 is a perspective view of the present invention;

FIG. 22 is a perspective view of the present invention;

FIG. 23 is an exploded perspective view of the present invention;

FIG. 24 is a perspective view of an exemplary case of the present invention;

FIG. 25 is an exploded view of an alternative embodiment of the present invention;

FIG. 26 is a perspective view of a connector of an embodiment of the present invention;

FIG. 27 is an exploded view of a connector of an embodiment of the present invention;

FIG. 28 is a section view taken along line 28-28 in FIG. 26; and

FIG. 29 is a top view illustrating rocker arm ends in between a plurality of teeth; and

FIG. 30 is a cross sectional view of a connector of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a tool handle and head adapted to secure different tool attachments, thereby creating different types of tools. The present invention is versatile, has many capabilities, and can be manipulated to create different types of tools, such as but not limited to, hammers, hacksaws, and mallets. The handle, head and tool attachments may be secured in a solid case. The present invention may save the consumer money and space.

The present invention may be used as a survival tool for those that enjoy camping and hunting. The present invention may also be used by carpenters, gardeners, campers, metal workers, archeologists, engineers, machinists, welders, survivalists, miners, mechanists, craftsmen, construction workers, and an everyday handy man and do it yourselfer.

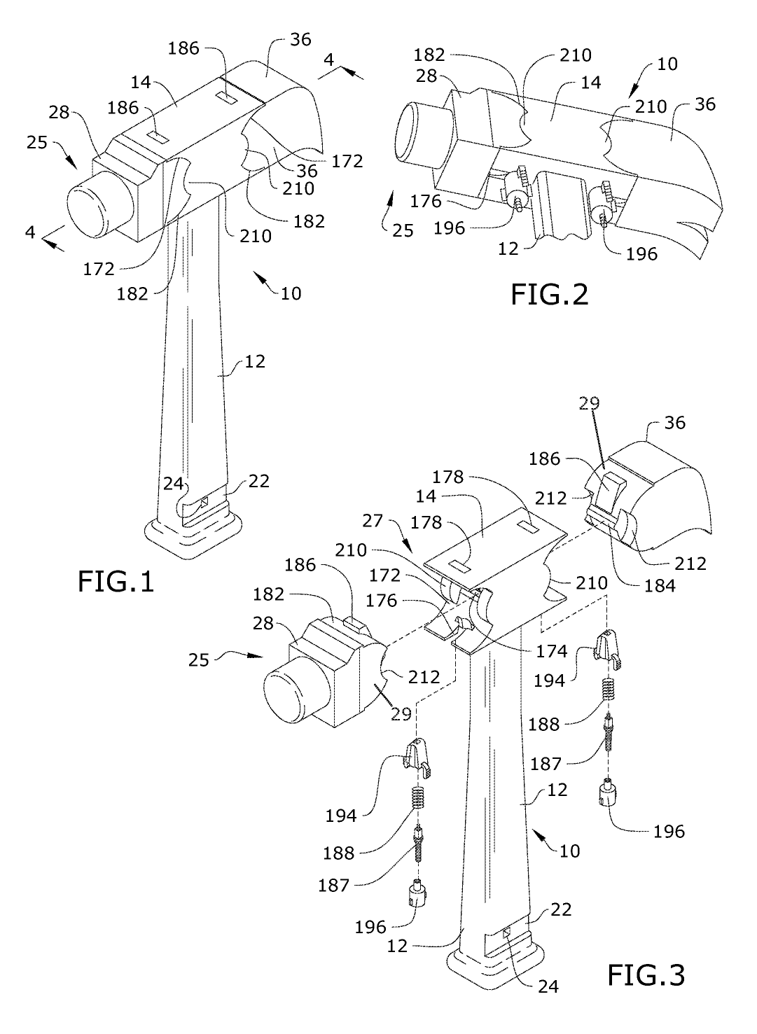

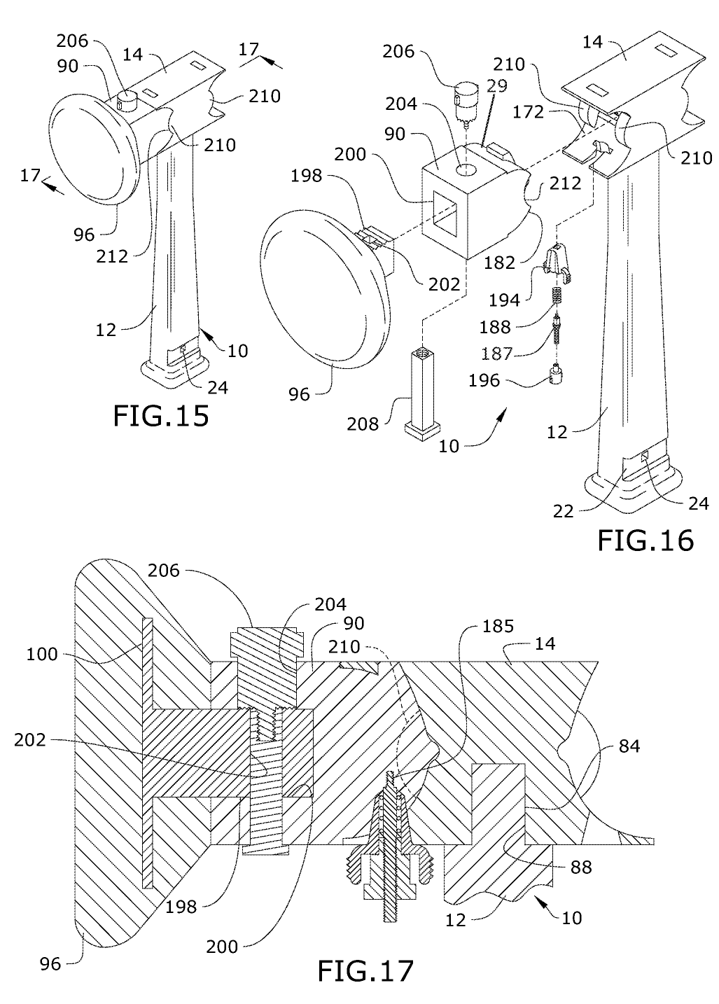

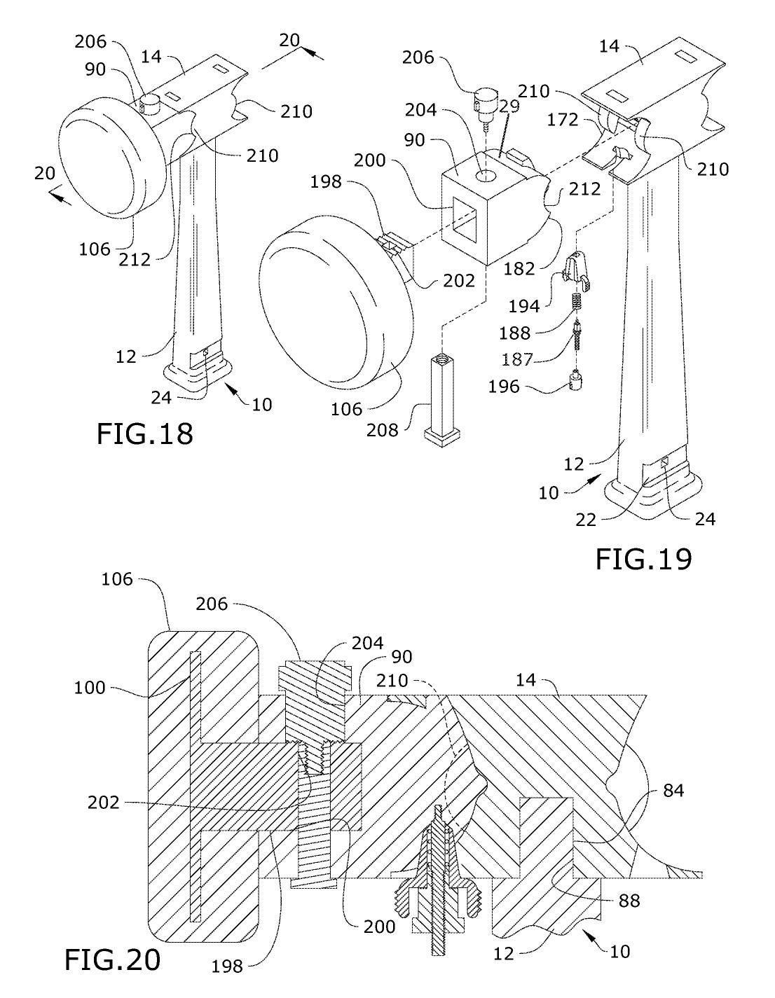

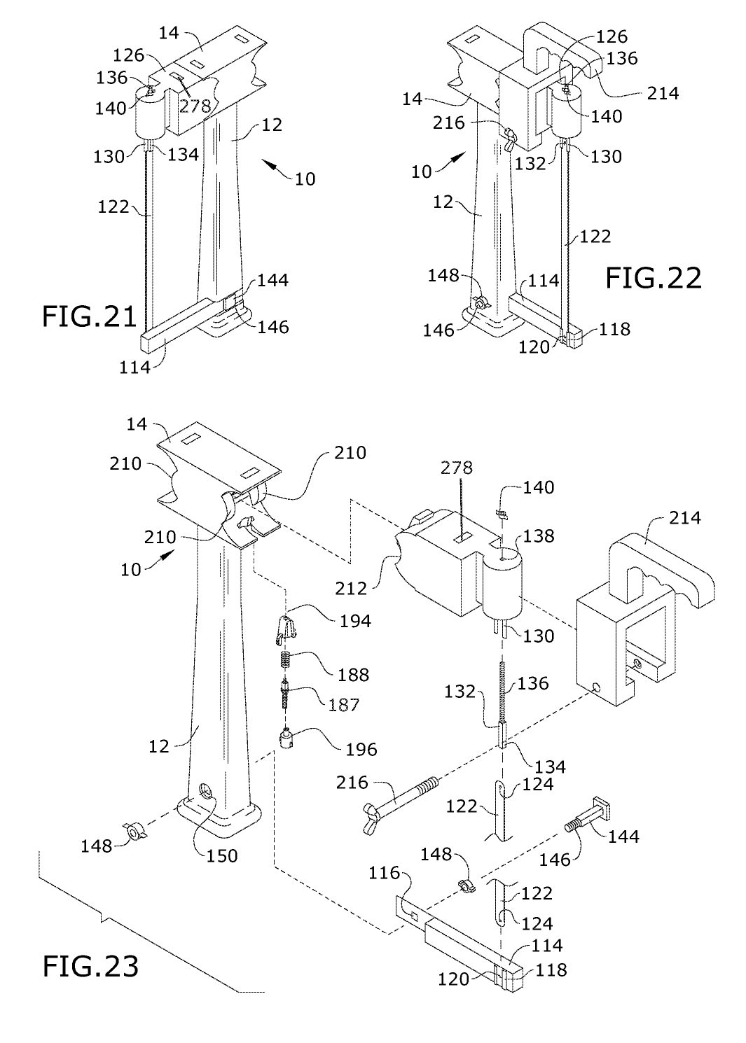

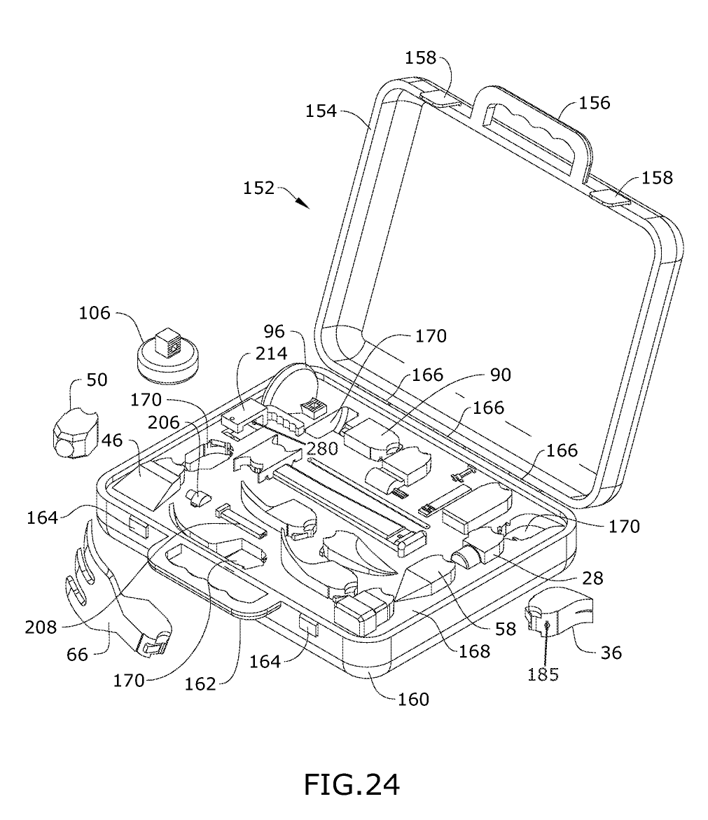

Referring to FIGS. 1 through 23, the present invention includes an adapter tool 10. The adapter tool 10 includes an elongated handle 12 having a top end opposite a bottom end. A head 14 is attached to and is substantially perpendicular with the handle 12. The head 14 includes a first end opposite a second end. At least one of the first end and the second end may include a head mating end 27. The present invention further includes a plurality of tool attachments 25. Each of the tool attachments 25 includes a tool mating end 29 releasably attachable to the head mating end 27. Each of the plurality of tool attachments 25 may include a tool portion including a different type of tool. Therefore, different tool attachments 25 may be connected to the head 14 to form different tools.

The handle 12 of the present invention may be made by a metal, fiberglass, wood, plastic or the like. A rubber sleeve may be secured over the handle 12 to provide additional comfort. The head 14 and tool attachments 25 may be made of a metal or other solid material. The head 14 may interface the tool attachments 25 to form a metal to metal even-forced distribution. The design of the present invention is capable of absorbing shock and to distribute force evenly. The head 14 and the handle 12 may be integral. However, in certain embodiments, the head 14 and the handle 12 may be releasably attachable. For example, looking at FIG. 17 the handle 12 may include a post 84 that fits within a slot 88 formed through the head 14 on both designs.

As illustrated in FIG. 1, the first end and the second end of the head 14 may each include a head mating end 27. In certain embodiments, the head mating end 27 includes a concave outer portion 172. The concave outer portion 172 forms an upper lip and a lower lip. Formed in between the upper lip and the lower lip are outer male slide tabs 210 having a convex shape. A concave mid slot 174 is formed at a center of the concave outer portion 172 in between the outer male slide tabs 210. A t-slot 176 is formed through the lower lip and a pin slot 178 is formed through the upper lip. The t-slot 176 includes an inner slot perpendicular to an outer slot. The outer slot may end at an edge of the lower lip.

The tool mating end 29 of the tool attachments 25 releasably secure to the head mating end 27. The tool mating end 29 may include a convex outer portion 182. The convex outer portion 182 forms an upper curved wall and a lower curved wall. Formed in between the upper curved wall and the lower curved wall are outer female slide slots 212 having a concave shape. A convex mid rail 184 is formed at a center of the convex outer portion 182 in between the outer female slide slots 212. A pin 186 protrudes from the upper curved wall and a threaded slot 185 is formed through the lower curved wall.

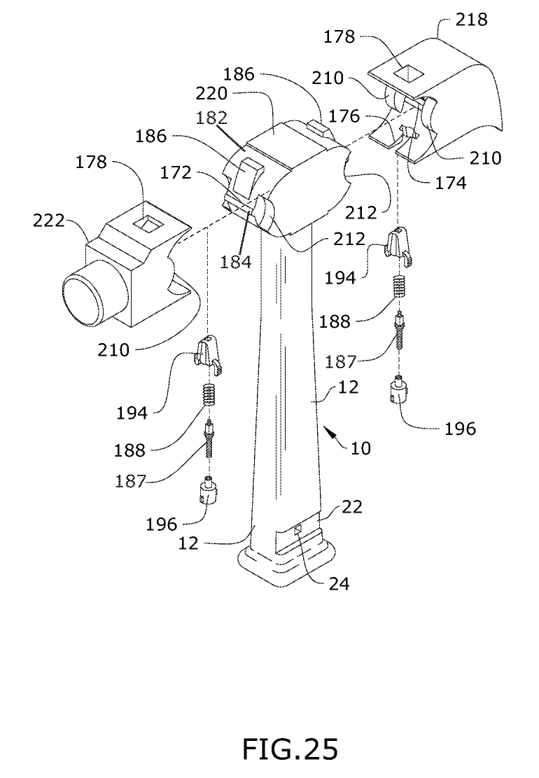

To releasably connect the tool attachments 25 to the head 14, the pin 186 is first inserted into the pin slot 178 and the tool mating end 29 is rocked into the head mating end 27. The convex outer portion 182 of the tool mating end 29 corresponds with and fits within the concave outer portion 172 of the head mating end 27. The convex mid rail 184 of the tool mating end 29 corresponds with and fits within the concave mid slot 174 of the head mating end 27. The outer male slide tabs 210 of the head mating end 27 corresponds with and fits within the outer female slide slots 212 of the tool mating end 29. The quick connect/disconnect will already be assemble to the attachments 25. Note to assemble the quick/connect disconnect, first put main spring/conical bushing spring 188 and threaded rod with main spring/conical bushing spring dispose over squared section into conical bushing 194. The squared section 192 will mate with the squared section conical bushing opening therefore making it turn all together when threading it into the threaded slot 185 of attachments 25 or FIG. 25 alternative design in head 220. The conical bushing arms will be grab to bias main spring/conical bushing spring to be pull out the slot. This will allow for the conical bushing 194 to be turn clockwise or counter clockwise while both conical bushing and threaded rod 190 and threaded rod 256 in the alternative wing nut/conical bushing FIG. 27. The tool slot 302 in FIG. 28 will allow for the threaded rod 256 to be tighten and torqued with a flat head screw driver into the thread slot 185. Note the tool slots are optional on both threaded rod 187 in FIGS. 3 and 256 in FIG. 30. The conical bushing 194 in FIG. 3 will then be released back into slot 185 by letting go of the arms 195 and main spring/conical bushing biasing the flange of threaded rod 194. The wing nut 196 will be then screwed loosely onto threads 190 of threaded rod 187. The quick connect/disconnect is now assembled on attachment 25 or FIG. 25 alternative design head 220. Note both designs are to assemble the same way and work with same principles. The quick/connect disconnect conical bushing 194 will meet with the lip of the t-slot 176 opening. The threaded rod 187 will go through opening of t-slot 176 as the conical bushing angle 276 meets the lip of t-slot 176 therefore compressing the conical bushing spring/main spring. The conical bushing spring/main spring will allow for the conical bushing to bias against threaded rod 187 flange and go over lip of t-slot 176 and allow conical bushing to rest in the perpendicular slot of t-slot 176. This will allow for the attachment 25 mating end 29 and the head mating end 27 to align up. The quick connect/disconnect wingnut 196 will be tighten. The wing nut serrated/tooth surface will engage inner radial horizontal surface of conical bushing 194 serrated/tooth surface to lock/secure attachment 25 to head 14. Note the quick connect/disconnect will be attached to the alternative embodiments FIG. 25 head 220 below lower curved wall on each side and work with same principles.

As illustrated in FIG. 25, an alternate head 220 may include a head mating end 29 having the convex outer portion 182, the outer female slide slots 212, the convex mid rail 184, the pin 186 and the threaded slot 185 to attach the quick connect/disconnect. In such embodiments in FIG. 25, alternate tool attachments 218, 222, such as a nail puller 218 and a hammer 222, may include a tool mating end 27 having a concave outer portion 172 forming the upper lip and the lower lip, outer male slide tabs, a concave mid slot 174, a t-slot 176 and a pin slot 178. In such embodiments, the head mating end 29 and the tool mating end 27 fit together as described above in a reverse configuration.

In certain embodiments, the quick connect/disconnect may include a conical bushing 194, a spring 188, a rod 187 with optional tool slot at end and a female threaded wingnut 196. The rod 187 may include a threaded body 190, a squared portion 192 and a threaded pin 193. The spring 188 may be disposed over the squared portion 192 and rest against a flange separating the squared portion 192 and the threaded body 190. The squared portion 192 and spring 188 fit within the conical bushing 194 so that an end of the squared portion 192 fits within a squared opening of the conical bushing 194 with the threaded pin 193 extending beyond the conical busing 194 to be threaded in the attachment head 25 threaded slot 185 or alternative embodiment FIG. 25 head 220 slot 185. The squared portion 192 disposed within the squared opening prevents rotation of the rod 187 relative to the conical bushing 194. The conical bushing 194 fits through the inner slot of the T-slot 176 and the threaded pin 193 mechanically fastens to the threaded slot 185 with the spring 188 disposed within an inner end of the conical bushing 194 and the flange.

In certain embodiments, the threaded wingnut 196 includes a narrow end and a serrated flange extending laterally from the narrow end. The threaded wingnut 196 may be torqued along the threaded body 190 until the narrow portion fits within the conical bushing 194 and abuts close to or against the flange. The serrated flange abuts against an inner wall of the conical bushing 194 radial circular horizontal serrated/teeth surface, preventing the threaded wingnut 196 from loosening. The conical bushing 194 tapers to a diameter larger than the inner slot of the T-slot 176. Therefore, the connector retains the tool attachment 25 to the head 14. The conical bushing 194 may further include outer arms 195 extending vertically from a bottom portion. The outer arms 195 may include a gripping portion, such as ridges, formed on an outer surface. When removing the connector from the tool attachment 25 and the head 14, the user may partially unscrew the wingnut 196 from the rod 187, pull the conical bushing 194 by the outer arms 195 against the bias of the spring until a narrow end of the conical busing 194 is able to slide out of the outer slot of the T-slot 176. The tool attachment 25 and the connector thereby quickly detach from the head 14. As illustrated in FIG. 25, the tool attachment 25 may slide off from the head 14 while the quick connect/disconnect is still connected to the head 14. Note the outer arms 195 can also be used to connect tool attachments in reverse also.

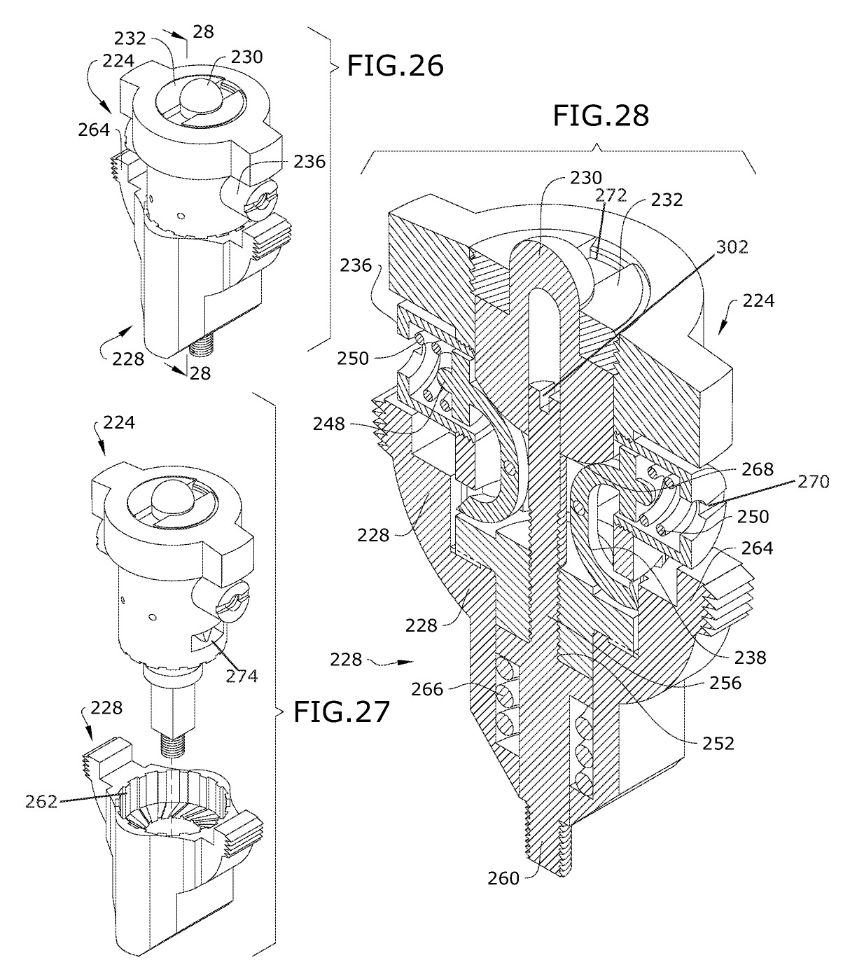

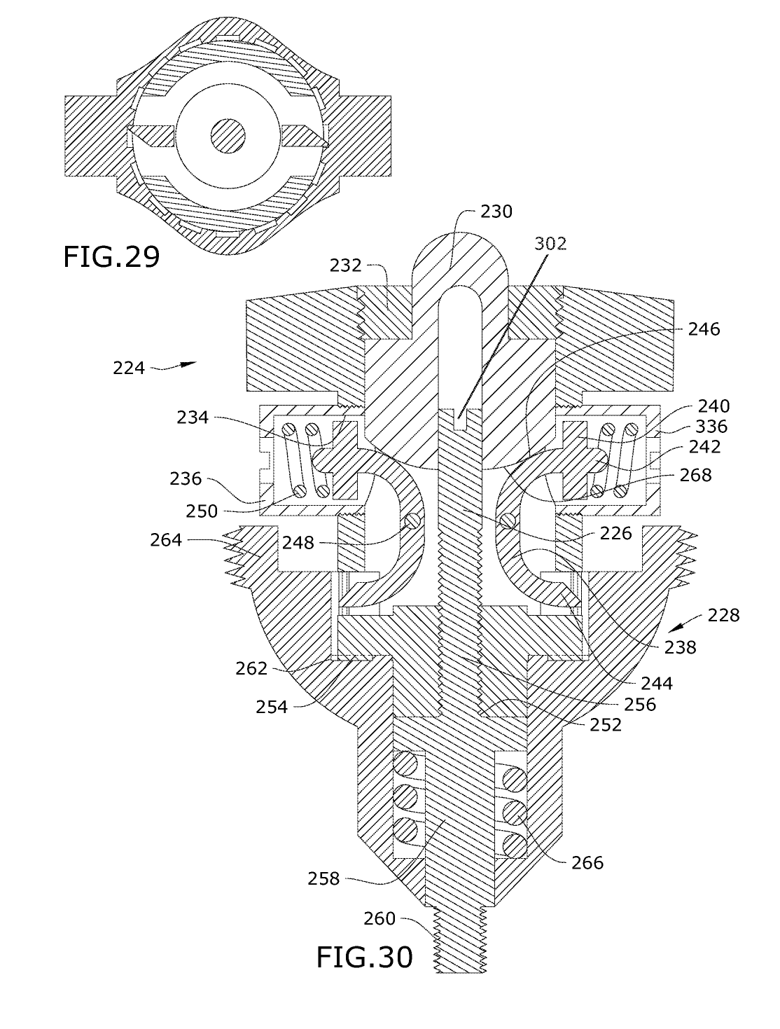

FIGS. 26 through 30 illustrate an alternate quick connect/disconnect. The connector includes a conical bushing 228, a main spring/conical bushing spring 266, a rod 226 and a threaded wingnut 224. The rod 226 with tool slot 302 may include a threaded body 256, a squared portion 258 and a threaded pin 260. The main spring 266 may be disposed over the squared portion 258 and rest against a flange separating the squared portion 258 and the threaded body 256. The squared portion 258 and the main spring 266 fit within the conical bushing 228 so that an end of the squared portion 258 fits within a squared opening of the conical bushing 228 with the threaded pin 260 extending beyond the conical busing 228. The squared portion 258 disposed within the squared opening prevents rotation of the rod 226 relative to the conical bushing 228. The conical bushing 228 fits through the inner slot of the T-slot and the threaded pin 260 mechanically fastens to the threaded slot 185. Note the quick connect/disconnect will be assembled to attachments or head of alternative design before it connect or disconnect.

The conical bushing 228 includes an inner surface defining a cylindrical vertical sidewall and a horizontal circular portion. The cylindrical vertical sidewall includes a plurality of radially extending teeth 262. The horizontal circular portion may also include a plurality radially extending teeth/serrated surface. 262. The conical bushing 228 may further include outer arms 264 extending laterally form an outer surface. The outer arms 264 may include a gripping portion, such as ridges. The conical bushing 228 tapers to a diameter larger than the T-slot 185. Therefore, the connector retains the tool attachment 25 to the head 14.

The threaded wingnut 224 mechanically fastens to the threaded rod 226 to prevent the conical bushing 228 from loosening. The threaded wingnut 224 includes a female threaded end 252 forming a narrow end and a toothed flange 254 extending laterally from the narrow end. The threaded wingnut 224 may be torqued along the threaded body 256 until the narrow portion fits within the conical bushing 228 and is adjacent or against the flange of the threaded rod 226. The toothed/serrated flange 254 interlocks with the radially extending teeth 262 of the horizontal circular portion, preventing the rotation of the threaded wingnut 224 relative to the conical bushing 228.

The threaded wingnut 224 further includes an internal housing. A top button 230 is secured to a top end of the threaded wingnut 224 by a threaded retainer ring 232 with tool slot 272. The top button 230 further includes an angled bottom end 268. For example, the bottom end may form a frusto conical shape. The sides of the threaded wingnut 224 may include threaded female side openings 234. Retainer cylinders 236 with tool slot 270 and male threads mechanically fasten to the threaded female side openings 234. Side springs 250 are disposed within the retainer cylinders 236. Rocker arms 238 are pivotally secured within the internal housing by pivot pins 248. The rocker arms 238 each include a head 240 having a pin 242, a pointed tail 244 that is angled and an angled body 246 that abuts against the bottom end of the top button 230. The heads 240 are disposed within the retainer cylinders 236 so that the side springs 250 spring bias the angle body 246 against the angled bottom end 268 of the top button 230. The rocker arms 238 thereby bias the top button 230 to protrude from the top end of the wingnut 224 abutting against a bottom of the retaining ring 232 with tool slots 272. The tail 244 protrudes from side openings 274 formed through the threaded wingnut 224.

In use, the rod 226 and the main spring 266 are placed within the conical bushing 228. The threaded pin 260 screwed into the threaded slot 185 using a screw driver to engage tool slots 302. The top button 230 is pressed, which pushes the heads 240 of the rocker arms 238 further into the retainer cylinders 236 against the bias of the side springs 250. The rocker arms 238 thereby pivot and the tails 244 of the rocker arms retract into the internal housing. The female threaded end 252 is screwed or torqued onto the threaded body 256 of the threaded rod 226 until the toothed/serrated flange 254 interlocks with the radially extending teeth/serrated surface 262 of the horizontal circular portion. The top button 230 is released. The side springs 250 bias the rocker arms to pivot the heads 240 away from the retainer cylinders 236. The tails 244 extend back through the side openings 274 and interlock with the plurality of radially extending teeth 262 of the cylindrical vertical sidewall. The interlocking of the rocker arms 238 and the radially extending teeth/serrated surfaces 262 further prevents the rotation of the threaded wingnut 224 relative to the conical bushing 228, which prevents the loosening from the tool attachments 25 head 14 or FIG. 25 head 220. To remove the above mentioned connector, the user may press against the top button 230, which retracts the tails 244 into the internal housing. The user may then partially unscrew the wingnut 224 from the rod 226, pull the conical bushing 228 by the outer arms 264 against the bias of the spring 266 until a narrow end of the conical busing 228 is able to slide out of the outer slot of the T-slot 176. The tool attachment 25 and the quick connect/disconnect thereby will quickly detach from the head 14. As illustrated in FIG. 25, the tool attachment 25 may slide off from the head 14 while the connector is still connected to the head 14.

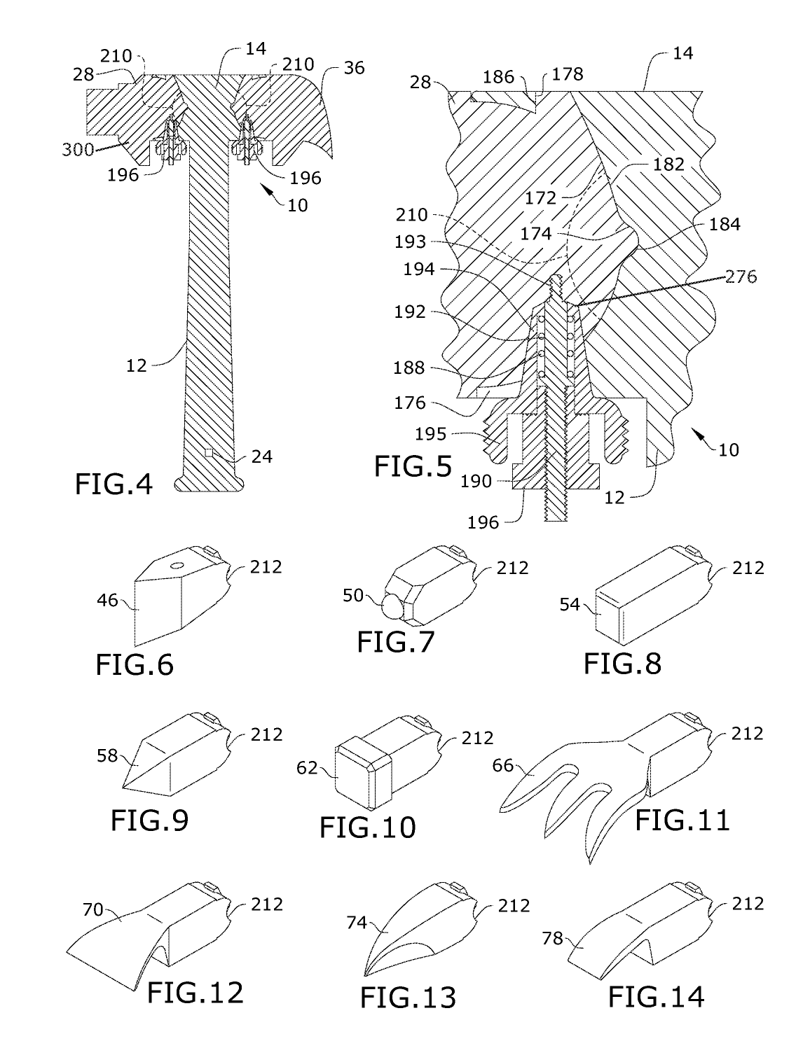

As illustrated in FIG. 4, the present invention may include a shield 300 protruding from a bottom potion of either the tool attachment 25 or head 14. Note the shield also pertain to the alternative design FIG. 25. The shield 300 may include an angled front surface to deflect mishits from hitting and breaking the connector.

The tool portion of the tool attachment 25 may include a variety of different tool types. The tool types may include, but are not limited to, a hammer 28, a nail puller 36, an axe 46, a ball peen hammer 50, a sledge hammer 62, a welder's hammer 58, an engineer's hammer 54, a cultivator 66, a grubbing hoe 70, a rear pick axe 74, a front pick axe 78, a mallet 96, 106, and a saw 122. In certain embodiments, the plurality of tool attachments 25 with different types of tool types may be stored in a case 152 with the handle 12 and head 14 or FIG. 25 alternative design. The case 152 may include a case top 154 connected to a case bottom 160 by hinges 166. The case top 154 includes a handle 156 and the case bottom 160 includes a handle 162. The case 152 may be closed by latches 158 engaging latch strikes 164. The case 152 may include a molded insert 168 with a plurality of tool cavities 170. Each tool attachment 25 may be stored within each of the tool cavities 170.

Multiple mallets 96, 106 may be secured to the head 14 of the present invention as shown in FIG. 16, FIG. 19 and other Figures. In such embodiments, the present invention may include a mallet adapter 90. The mallet adapter 90 includes the tool mating end 29 formed on a first end, a female slot 204 running from the top to the bottom and a front female slot 200 formed on a second end. The present invention may include a rubber mallet head 96 having an internal distribution plate 100 and post 198. The post 198 with serrated/toothed surface includes a pin slot 202 formed therethrough. The post 198 fits within the front female slot 200 of the mallet adapter 90 so that the pin slot 202 and the female slot 204 align. A stem body 208 fits through the aligned pin slot 202 and the female slot 204 and a torque head 206 mechanically fastens to the stem body 208 by threaded connectors, thereby attaching the rubber mallet head 96 to the mallet adapter 90. In certain embodiments, the torque head 206 may be the alternative wingnut 224 of FIG. 26. In such embodiments, the stem body 208 may include a male threaded portion that mechanically fastens to the female threaded end 252 of the wingnut 224. The female slot 204 may include a plurality of teeth along the internal sidewall that interlock with pointed tails 244 of the rocker arms 238. The present invention may further include a plastic mallet head 106 including the same connecting components described above. The plastic mallet head 106 may also releasably secure to the mallet adapter 90 which releasably secures to the head 14 like other attachments show in FIG. 3, FIG. 25 and other Figures.

To attach the saw 122 to the adapter tool 10, the present invention may include an upper adapter 126 and a lower adapter 114. The upper adapter 126 may include the tool mating end 29 that is releasably attachable to the head mating end 27. The upper adapter 126 may further include a vertical slot 138 with an upper blade guide 130 attached below the vertical slot 138. A bolt 134 having a top end and a bottom end may run through the vertical slot 138. The top end of the bolt 134 includes a threaded portion 136. A wing nut 140 secures to the threaded portion 136 at a top end of the slot 138, thereby securing the bolt 134 to the upper adapter 126. The wing nut 140 may also be used to adjust the tension applied to the saw 122. The bottom end of the bolt 134 may include an upper blade hook 132, which is disposed within the upper blade guide 130. The lower adapter 114 includes a first end and a second end. The first end is secured within a lower handle slot 22 formed on the second end of the handle 12. The lower adapter 114 may include an opening 116 and the handle 12 may include an opening 24. A bolt 144 may releasably secure the lower adapter 114 to the handle 12 through the aligned openings 24, 116. A winged nut 148 may screw onto a thread portion 146 of the bolt 144 and be secured within a nut recess 150. The lower adapter 116 includes a lower blade guide 118 with a lower blade hook 120 disposed within. The saw 122 may include an upper blade screw hole 124 and a lower blade screw hole 124. The blade screw holes 124 may be secured to the blade hooks 132, 120, and thereby attaches the saw 122 to the adapter tool 10. A saw handle 214 may include a bracket portion and a handle portion. The bracket portion may include a base and arms extending from opposing sides of the base. The handle portion may include finger groves and protrudes from the base of the bracket portion. The bracket portion fits over the upper adapter 126. An internal notch 280 of the bracket fits within a slot 278 formed on the top of the upper adapter 126 and a bolt 216 may run through aligned openings formed through the arms, securing the upper adapter 126 in between the base of the bracket portion and the bolt 216. Note some or all of the designs could be optional.

It should be understood, of course, that the foregoing relates to exemplary embodiments of the invention and that modifications may be made without departing from the spirit and scope of the invention as set forth in the following claims.

What is claimed is:

1. An adapter tool comprising:
a handle comprising a top end and a bottom end;
a head attached to the top end of the handle and comprising a first end and a second end, wherein at least one of the first end and the second end comprises a head mating end comprising a head opening;
a plurality of tool attachments, each comprising:
a tool mating end comprising a tool opening positioned to align with the head opening, wherein one of the tool opening and the head opening is a threaded opening and the other of the tool opening and the head opening is a T-slot comprising an inner slot perpendicular to an outer slot, wherein the outer slot ends at an edge; and
a tool portion comprising a type of tool; and
a connector comprising:
a conical bushing sized to fit within at least one of the tool opening and head opening;
a bolt disposed within the conical bushing and comprising a flange and a threaded pin;
a spring disposed around the bolt in between the threaded pin and the flange, wherein
the threaded pin is protruding from an end of the conical bushing and is releasably attachable to the threaded opening.

2. The adapter tool of claim 1, wherein the first end and the second end of the head each comprise a head mating end.

3. The adapter tool of claim 1, wherein one of the head mating end and the tool mating end comprises a pin and the other of the head mating end and the tool mating end comprises a pin slot sized to receive the pin.

4. The adapter tool of claim 1, wherein the connector further comprises a wingnut comprising a female threaded end mechanically fastened to a male threaded portion of the bolt, wherein the female threaded end abuts against the flange.

5. The adapter tool of claim 4, wherein the wingnut further comprises a plurality of teeth interlocked with a plurality of teeth formed within the conical bushing.

6. The adapter tool of claim 4, wherein the wingnut further comprises:
a button protruding from a top end;
a pair of rocker arms pivotally secured within an internal housing of the wingnut, wherein each of the rocker arms comprises a head and a tail, wherein the tail protrudes through openings formed in the wingnut and interlock with a plurality of teeth formed within the conical bushing; and
side springs biasing the head of the rocker arms inward towards one another so that the rocker arms are spring biased against the button.

7. The adapter tool of claim 1, wherein one of the head mating end and the tool mating end comprises a convex outer portion that corresponds with and fits within a concave outer portion of the other of the head mating end and the tool mating end.

8. The adapter tool of claim 1, wherein one of the head mating end and the tool mating end comprises a convex mid rail that corresponds with and fits within a concave mid slot of the other of the head mating end and the tool mating end.

9. The adapter tool of claim 1, wherein one of the head mating end and the tool mating end comprises outer male slide tabs that corresponds with and fits within outer female slide slots of the other of the head mating end and the tool mating end.

10. The adapter tool of claim 1, wherein the type of tool comprises one of a hammer, a nail puller, an axe, a ball peen hammer, a sledge hammer, a welder's hammer, an engineer's hammer, a cultivator, a grubbing hoe, a rear pick axe, a front pick axe, a mallet, and a saw.

11. The adapter tool of claim 10, wherein the tool attachment comprising the saw comprises:
an upper adapter comprising the tool mating end releasably attachable to the head mating end, and a top blade guide;
a lower adapter releasable attachable to the bottom end of the handle and comprising bottom blade guide; and
a hacksaw blade releasably attachable within the top blade guide and the bottom blade guide.

12. The adapter tool of claim 11, wherein the handle comprises a lower handle slot sized to receive a portion of the lower adapter and comprising an opening aligned with an opening formed through the lower adapter, wherein a bolt releasably secures the lower adapter to the handle through the aligned openings.
